(19) United States
(12) Patent Application Publication
(10) Pub. No.: US 2025/0056367 A1
(43) Pub. Date: Feb. 13, 2025

(54) METHODS AND NETWORK NODES FOR HANDLING HANDOVER OF A USER EQUIPMENT

(71) Applicant: Telefonaktiebolaget LM Ericsson (publ), Stockholm (SE)

(72) Inventors: Daniel HENRIKSSON, Linköping (SE); Linnea JOHNANDER FAXÉN, Linköping (SE); Veronika BROZ, Sesvete (HR); Jan ERIKSSON, Vikingstad (SE); Thomas HELANDER, Linköping (SE)

(21) Appl. No.: 18/720,075

(22) PCT Filed: Dec. 15, 2021
(86) PCT No.: PCT/SE2021/051261

§ 371 Date: Jun. 14, 2024

(51) Int. Cl. H04W 36/36; H04B 7/0413

(52) U.S. Cl. CPC H04W 36/362; H04B 7/0413

(57) ABSTRACT

Disclosed is a method performed by a serving network node of a wireless communication network, the serving network node serving a UE, the serving network node handling a serving cell. The method comprises determining, based on capabilities of the UE, on configuration parameters of neighboring cells and the serving cell as well as on channel quality of signals received by the UE from network nodes handling the neighboring cells as well as on channel quality of signals received by the UE from the serving network node, a primary cell and at least one secondary cell for the UE. The method further comprises, when the determined primary cell is handled by a target network node, which is different from the serving network node, sending a handover message towards the target network node.

### TECHNICAL FIELD

The present disclosure relates generally to methods and network nodes for handling handover of a user equipment (UE). The present disclosure further relates to computer programs and carriers corresponding to the above methods and network nodes.

### BACKGROUND

In wireless communication there is a constant demand on higher data rates and thereby higher throughput over wireless communication interfaces between a UE and a network node, aka base station.

Carrier aggregation (CA) is an effective technique in Long Term Evolution (LTE) and New Radio (NR) to enhance throughput from/to a UE. With CA, a UE can be served with multiple carrier components (CC) and access larger bandwidth than being served with only one carrier. To apply CA, a UE firstly establishes a radio resource control (RRC) connection with a primary serving cell aka primary cell (PCell). Then the network node handling the PCell adds and removes secondary serving cells aka secondary cells (SCell) to/from the UE with RRC reconfiguration messages, depending for example on the required throughput of the UE. In order to improve UE throughput, the added SCell should have not only a good radio link to the UE but also large amount of radio resources that it can use to serve the UE, i.e., the added SCell should not be heavily loaded. How to properly configure the SCells of a UE is essential in the application of CA. When configuring SCells, the network node also needs to take the capabilities of the UE into account.

In NR and LTE, the UE informs the network about its capabilities, i.e., the UE informs the network which features and functions it supports. The network (NW) needs to take those capabilities and its own configuration into account when deciding how to configure a UE, i.e., which features to use. The UE capabilities determine which band combinations and carrier aggregation configurations that the UE supports, the number of supported Multiple Input Multiple Output (MIMO) layers and modulation order, supported subcarrier spacings and carrier bandwidths, etc. However, there are many more capabilities, especially in the physical layer area. The large amount of UE capabilities for NR are signaled via RRC, see e.g. TS 38.331, V 16.6.0, section 6.3.3. The NW should only configure those features if the UE reports the corresponding capability parameters.

One task for a network node serving a UE is to evaluate different cells to configure for the specific UE. In the context of CA, this procedure should configure the UE with the best possible alternatives of PCell and SCells. This may be called traffic steering. One traffic steering application could aim for maximizing the throughput for the ongoing connection for a specific UE. The network node would then gather information about the surrounding cells aka neighboring cells like static configuration and dynamic parameters like load. It should also take the UE capabilities into account when deciding the best set of cells, i.e. PCell and SCells, for the UE. Other information to take into account is if target cells different than the current serving cell are in coverage or not and, if possible, the channel quality for each target cell. Once the network node has determined the best set of cells for a specific UE, the UE is requested to perform handover towards the target PCell. In connection with the UE being requested to perform handover to the target cell, the serving network node sends a handover request message to the network node handling the target cell, including the ID of the target cell. In the handover process, the network node handling the target cell then checks if it can handle the request and thereafter sends a handover request acknowledgement message back to the serving network node. Then the serving network node sends a RRC reconfiguration handover command to the UE, which connects to the target node.

### SUMMARY

It is an object of the invention to address at least some of the problems and issues outlined above. Embodiments of the present invention aim to improve the current UE handover process. It is possible to achieve these objects and others by using methods, network nodes and wireless devices as defined in the attached independent claims.

According to one aspect, a method is provided that is performed by a serving network node of a wireless communication network, the serving network node serving a UE and the serving network node handling a serving cell. The method comprises determining, based on capabilities of the UE, on configuration parameters of neighboring cells and the serving cell as well as on channel quality of signals received by the UE from network nodes handling the neighboring cells as well as on channel quality of signals received by the UE from the serving network node, a primary cell and at least one secondary cell for the UE. When the determined primary cell is handled by a target network node, which is different from the serving network node, the method comprises sending a handover message towards the target network node, the handover message comprising ID of the determined primary cell. In addition, the handover message further comprises ID(s) of the determined at least one secondary cell.

According to another aspect, a method is provided that is performed by a target network node of a wireless communication network, the target network node handling a target cell. The method comprises receiving a handover message from a serving network node serving a UE, the handover message comprising an ID of a determined primary cell for the UE, the primary cell being the target cell, and ID(s) of determined at least one secondary cell for the UE. The method further comprises determining whether to set up the determined target cell as primary cell for the UE and whether to set up the determined at least one secondary cell as secondary cell for the UE.

According to another aspect, a serving network node is provided that is configured to operate in a wireless communication network for serving a UE, the serving network node being configured to handle a serving cell. The serving network node comprises a processing circuitry and a memory. Said memory contains instructions executable by said processing circuitry, whereby the serving network node is operative for determining, based on capabilities of the UE, on configuration parameters of neighboring cells and the serving cell as well as on channel quality of signals received by the UE from network nodes handling the neighboring cells as well as on channel quality of signals received by the UE from the serving network node, a primary cell and at least one secondary cell for the UE. The serving network node is further operative for, when the determined primary cell is handled by a target network node, which is different from the serving network node, sending a handover message towards the target network node, the handover message comprising an ID of the determined primary cell and IDs of the at least one secondary cell.

According to another aspect, a target network node is provided that is configured to operate in a wireless communication network, the target network node being configured to handle a target cell. The target network node comprises a processing circuitry and a memory. Said memory contains instructions executable by said processing circuitry, whereby the target network node is operative for receiving a handover message from a serving network node serving a UE, the handover message comprising an ID of a determined primary cell for the UE, the primary cell being the target cell, and IDs of determined at least one secondary cell for the UE, and determining whether to set up the determined target cell as primary cell for the UE and whether to set up the determined at least one secondary cell as secondary cell for the UE.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic view of a wireless communication network in which the present invention may be used.

FIG. 2 is a flow chart illustrating a procedure of a serving network node for handling handover of a UE, according to possible embodiments.

FIG. 3 is a flow chart illustrating a procedure of a target network node in connection with handover of a UE, according to possible embodiments.

FIG. 4 is a schematic view of another wireless communication network in which the present invention may be used.

FIG. 5 is a signaling diagram of a handover procedure in which embodiments of the present invention may be used.

FIGS. 6a and 6b are signaling diagrams of another handover procedure in which embodiments of the present invention may be used.

FIG. 7 is a block diagram illustrating a serving network node in more detail, according to further possible embodiments.

FIG. 8 is a block diagram illustrating a target network node in more detail, according to further possible embodiments.

### DETAILED DESCRIPTION

Briefly described, a solution is provided to improve the current handover process of a UE, especially when carrier aggregation (CA) is involved. Some embodiments aim to improve the current UE handover process by reducing the time to setup CA in connection with handover. This may be achieved by the current serving network node, apart from sending in the handover message the ID of the determined target primary cell to the target network node handling the target primary cell, also sending the ID(s) of the secondary cell(s) the current serving network node determined as the best set of cells for the UE. Then the target network can set up a secondary connection for the UE with the secondary cell(s) directly, or at least evaluate whether to set up such a secondary connection. As a result, the configuration time for setting up carrier aggregation at the target network node as well as the processing required on the target network node will decrease.

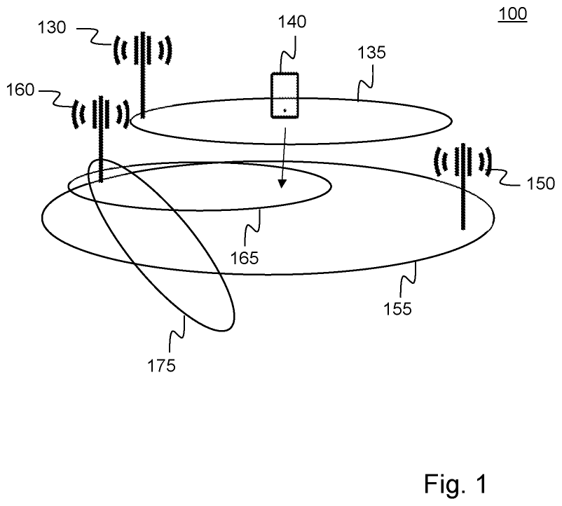

FIG. 1 shows an example of a wireless communication network 100 in which the present invention may be used. The wireless communication network 130 comprises a first radio access network (RAN) node aka network node 130 that is in, or is adapted for, wireless communication with a wireless communication device aka user equipment (UE) 140. The first network node 130 provides radio access in a first cell 135. The first network node is here called a serving network node as it serves or is adapted for serving the UE 140 with radio access. The first cell is for the same reason called a serving cell. The wireless communication network 100 further comprises a second network node 150 providing radio access in a second cell 155 and a third network node 160 providing radio access in a third cell 165 and a fourth cell 175. The second, third and fourth cells 155, 165, 175 are called neighboring cells as they are geographically more or less close to the serving cell 135. The UE 140 has capabilities to be in carrier aggregation (CA) mode. Therefore, the serving network node 135 evaluates best primary cell and secondary cell for the UE based on the UE capabilities, configuration parameters of the serving cell and neighboring cells and channel quality of signals received by the UE 140 from the network nodes 150, 160 handling the neighboring cells 155, 165, 175 as well as on channel quality of signals received by the UE from the serving network node 130.

Based on the above-mentioned evaluation, the serving network node 130 determines that the UE 140 should be best served in CA by the second cell 155 being primary cell and the third cell 165 being secondary cell. The second cell 155 is therefore called a target cell or primary cell in this context, and the second network node 150 a target network node. As a result of the determination, the serving network node 130 initiates handover to the second cell 155 (illustrated by the arrow from cell 135 to cell 155 in FIG. 1) by sending a handover message to the target network node 150, including the ID of the target cell 155. In addition, and according to embodiments, also the ID of the third cell 165, which was determined as the best secondary cell for the UE is sent in the handover message. Hereby, the time for setting up CA at the new primary cell 155 is decreased.

The wireless communication network 100 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The network nodes 130, 150, 160 may each be any kind of network node that can provide wireless access to the UE alone or in combination with another network node. Examples of network nodes 130, 150, 160 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH) and a multi-standard BS (MSR BS).

The UE 140 may be any type of device capable of wirelessly communicating with a network node 130 using radio signals. For example, the UE may be a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

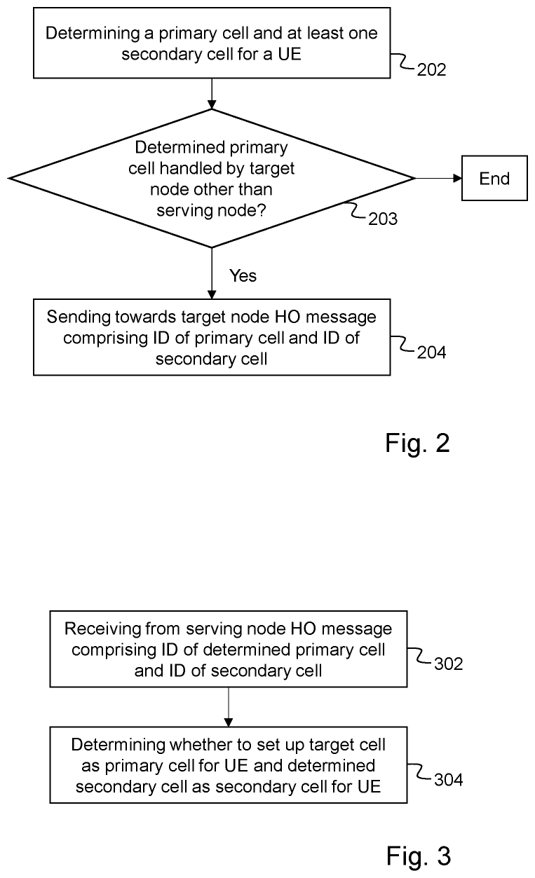

FIG. 2, in conjunction with FIG. 1, describes a method performed by a serving network node 130 of a wireless communication network 100, the serving network node 130 serving a UE 140 and the serving network node handling a serving cell 135. The method comprises determining 202, based on capabilities of the UE 140, on configuration parameters of neighboring cells 155, 165, 175 and the serving cell 135 as well as on channel quality of signals received by the UE 140 from network nodes 150, 160 handling the neighboring cells 155, 165, 175 as well as on channel quality of signals received by the UE from the serving network node 130, a primary cell 155 and at least one secondary cell 165 for the UE 140. When the determined primary cell 155 is handled 203 by a target network node 150, which is different from the serving network node 130, the method comprises sending 204 a handover message towards the target network node 150, the handover message comprising ID of the determined primary cell 155. In addition, the handover message further comprises ID(s) of the determined at least one secondary cell 165.

The handover message may also comprise ID of the UE (140). Alternatively, the target network node 150 informs the serving network node 130 of a specific preamble to use during random access. This in included in UE configuration parameters sent back to the serving network node 130 before handover. The serving network node 130 sends this to the UE 140 in e.g., a RRC reconfiguration message and the UE uses the preamble towards the target network node 150 during random access. In this alternative it is not necessary to send the UE ID in the handover message from the serving network node 130 to the target network node 150. The primary cell 155 and at least one secondary cell 165 for the UE 140 are part of the neighboring cells. The determining 202 of primary and secondary cells may be triggered by one or more events such as the UE coming into coverage of new cells, at connection setup or RRC resume or by a periodic timer. Examples of UE capabilities may be which carrier bandwidths that are supported, carrier aggregation configurations, number of supported MIMO layers, modulation order, which carriers that can be combined in carrier aggregation, etc. Examples of configuration parameters of neighboring cells and serving cell may be bandwidth, number of MIMO layers, Time Division Duplex (TDD) or Frequency Division Duplex (FDD), TDD pattern, Subcarrier spacing, etc. Channel quality may be determined from measurement on signals received by the UE 140. Channel quality may be measured as signal strength, Signal to Noise Ratio (SNR), Signal to Interference and Noise Ratio (SINR), etc. The UE 140 measures the channel quality of the signals the UE receives from the network nodes 150, 160 handling the neighboring cells 155, 165, 175 as well as from the serving network node 130. The serving network node 130 then receives from the UE 140, information on the channel quality of the signals the UE 140 has received from the network nodes 150, 160 handling the neighboring cells 155, 165, 175 as well as information on the channel quality of the signals the UE 140 has received from the serving network node 130. The serving network node 130 uses that information on channel quality to determine the primary cell and the at least one secondary cell for the UE 140.

By the serving network node 130 sending to the target network node 150, except for the ID of the primary cell also the IDs of the one or more secondary cells it has determined, configuration of SCells in coverage can be performed faster at the target network node 150 in connection with handover compared to today's method where the IDs of the one or more secondary cells are not sent. Also, the computational costs for the target network node 150 decreases as the determinations from the serving network node/source node is re-used. Another advantage is that no new measurements may be needed in the target network node 150 for finding secondary cells in coverage.

According to an embodiment, the determining (202) further comprises determining a secondary cell group (SCG) comprising a Primary Secondary Cell (PSCell) of the SCG as well as at least one Secondary Cell (SCell) of the SCG, and wherein the handover message further comprises ID of the PSCell and ID(s) of the at least one SCell of the SCG. By sending the IDs of the SCG, the target network node can quicker set up an SCG if needed.

According to another embodiment, the handover message further comprises MIMO configuration parameters such as number of MIMO layers, or Layer 1 configuration parameters for the UE (140).

According to another embodiment, the ID of the determined 202 primary cell 155 and the ID(s) of the at least one secondary cell 165 are Cell Global identities, CGIs. CGI is a unique Cell ID of the wireless communication network. PCI is not unique and since there is a limited number to choose from, in NR there are just 1008 different PCIs, PCI can only be locally unique. Also, the same PCI can be used by cells covering the same area but on different frequencies, so only sending PCI will in most cases not be enough to identify target cell.

According to another embodiment, the handover message further comprises information on channel quality of signals received by the UE 140 from the target network node 150 handling the primary cell 155 and on channel quality of signals received by the UE 140 from the network node 160 handling the at least one secondary cell 165. The UE 140 measures the channel qualities of the received signals and sends information on the channel qualities to the serving network node 130 that in its turn sends information on the measured channel qualities of the determined primary cell 155 and the at least one secondary cell 165 to the target network node 150. By receiving not only the IDs of the primary and the secondary cells determined by the serving network node 130 but also the channel qualities of those cells, the target network node 150 has even more information for determining whether to accept the received IDs of secondary cells as the secondary cells for CA for the UE 140 in connection with handover.

According to yet another embodiment, the handover message further comprises information on which frequencies that were considered for the channel quality when the primary cell and the at least one secondary cell was determined 202. By, in the handover message, also sending information on which frequencies the UE measured channel quality, the target network node 150 would know if there are any frequencies that itself or any of its neighboring nodes handle that have not been taken into consideration by the serving network node 130 and can hereby decide whether to do an own search for channel quality on those frequencies.

According to yet another embodiment, the handover message further comprises information on channel quality of signals received by the UE 140 from network nodes handling other of the neighboring cells that were not being determined 202 as the primary cell or any of the one or more secondary cells, as well as IDs of those cells. By also sending information in the handover message of the channel qualities of other cells that were measured but not selected as primary or secondary cell, the target network node 150 can also take such information into consideration when determining whether to set up the target cell 155 as primary cell for the UE 140 and the at least one secondary cell 165 as secondary cell for the UE 140.

FIG. 3, in conjunction with FIG. 1, describes a method performed by a target network node 150 of a wireless communication network 100, the target network node 150 handling a target cell 155. The method comprises receiving 302 a handover message from a serving network node 130 serving a UE 140, the handover message comprising an ID of a determined primary cell for the UE, the primary cell being the target cell 155, and ID(s) of determined at least one secondary cell 165 for the UE. The method further comprises determining 304 whether to set up the determined target cell 155 as primary cell for the UE and whether to set up the determined at least one secondary cell 165 as secondary cell for the UE.

The primary cell and the at least one secondary cells have been determined by the serving network node 130 based on capabilities of the UE 140, on configuration parameters of neighboring cells 155, 165, 175 and the serving cell 135 as well as on channel quality of signals received by the UE 140 from network nodes 150, 160 handling the neighboring cells 155, 165, 175 as well as on channel quality of signals received by the UE from the serving network node 130. The target cell 155 is among the neighboring cells 155, 165, 175.

By the target network node 150 determining whether to set up the target cell 155 as primary cell for the UE and whether to set up the at least one secondary cell 165 as secondary cell for the UE gives the target network node control of the handling of its own resources. It can be assumed that mostly the target network node will accept the at least one secondary nodes sent by the serving network node but it may be situations when it may be not accepted. One such reason could be that the target network node 150 considers that the UE 140 does not need the extra SCell capacity when having the target cell as primary cell. It could also be that target network node 150 has information about that the secondary cell is not accessible or overloaded.

According to an embodiment, the received 302 handover message further comprises an ID of a determined PSCell of an SCG for the UE and IDs of a determined at least one SCell of the SCG.

According to another embodiment, the received 302 handover message further comprises MIMO configuration parameters such as number of MIMO layers, or Layer 1 configuration parameters for the UE 140.

According to another embodiment, the received 302 handover message further comprises information on channel quality of signals received by the UE 140 from the target network node 150 handling the determined primary cell 155 and on channel quality of signals received by the UE from the network node 160 handling the determined at least one secondary cell 165.

According to yet another embodiment, the received 302 handover message further comprises information on which frequencies the serving network node 130 considered when it determined the primary cell and the at least one secondary cell for the UE.

According to yet another embodiment, the received 302 handover message further comprises information on channel quality and ID of other cells evaluated by the serving network node but not being determined by the serving network node 130 as the primary cell or any of the one or more secondary cells.

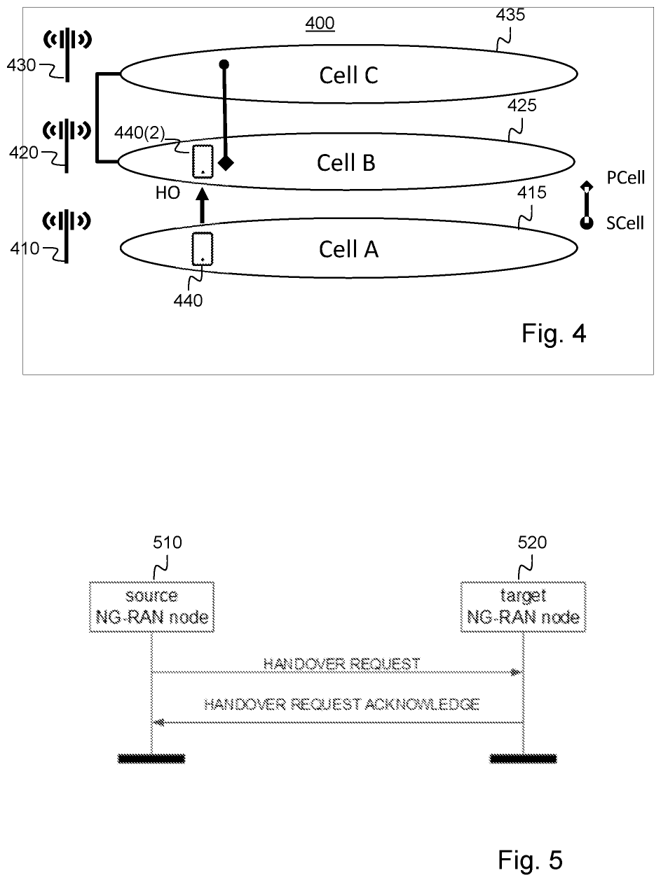

FIG. 4 shows an example of a wireless communication network 400 comprising a serving network node 410 providing radio access in a serving cell 415, a target network node 420 providing radio access in a target cell 425, which is a neighbor cell to the serving cell 415, and another network node 430 providing radio access in another neighbor cell 435. Further, network node 410 is called serving network node as it is serving a UE 440. The UE 440 has capabilities to aggregate the target cell 425 and the another neighbor cell 435, which the UE 440 has indicated to the serving network node 410 via the UE capabilities. As the serving network node 410 calculates the optimal CA cell set for the UE based on the UE 140 capabilities, configuration parameters of cells and channel quality of the cells, the serving network node 410 concludes that the UE 440 will experience better performance if it performs a handover (HO) to target cell 425 and then aggregates the another neighbor cell 435 as a SCell. The serving network node 410 will therefore initiate a HO procedure for the UE 440 towards the target network node 420 that handles the target cell 425. The arrow in FIG. 4 symbolizes handover of serving cell for the UE from cell 410 to the target cell 425. The HO procedure is initiated by the serving network node 410 sending a HO message to the target network node 420. According to embodiments of the invention, the serving network node 410 would send traffic steering information including the calculated optimal cell set in the HO message, that is not only the ID of the target cell 425 but also the ID of the another neighbor cell 435 as a SCell. That would eliminate the need for the target network node to perform calculation of new cell set after the HO is finalized. The sent traffic steering information may also include MIMO configuration for the UE.

FIG. 5 shows how the handling of handover requests is described for NR today as in 3GPP TS 38.423 v16.7, FIG. 8.2.1.2-1. Here the serving network node is called source node 510. NG-RAN stands for Next Generation RAN. The source node 510 sends a Handover Request to the target node 520, and the target node 520 responds by a Handover Request Acknowledge. The Handover Request contains a large number of handover parameters. One way of conveying the traffic steering information mentioned above, that is the calculated optimal cell set and possibly the MIMO configuration in the HO message could be to add extra information elements (IE) into the Handover Request. The extra IE could be called Traffic Steering Data and contain a Suggested SCell list, which contains SCell nCGI, where “n” in nCGI stands for NR. Also, MIMO configurations like number of MIMO layers, and/or Layer 1 configuration may be indicated as an IE. The information sent in the Handover Request message can then be used by the target node 520 directly when configuring the UE with for example SCells. This means that the target node 520 does not need to spend time on calculating the best cell set, which will both save computational effort on the target node and speed up the SCell selection.

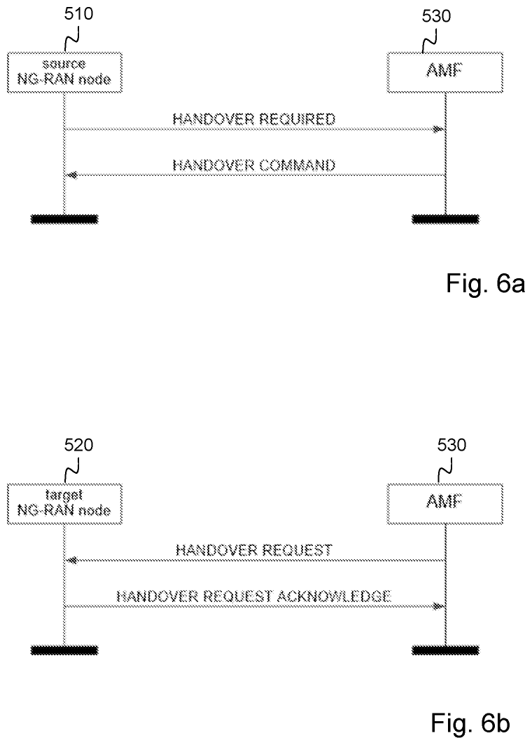

Another way of sending the information from source node 510 to target node 520 could be to use a NG HO procedure described in 3GPP TS 38.413 v16.7, which in a normal case would be a combination of two procedures Handover preparation, which is shown in FIG. 6a and Handover Resource allocation which is shown in FIG. 6b. In this type of NG HO procedure, the source node 510 and the target node 520 communicate via an Access and Mobility Management Function (AMF) 530 of the wireless communication network. The source node 510 sends the HO message as a Handover Required to the AMF 530. The AMF 530 sends the HO message further to the target node 520 as a Handover Request. The target node 520 then responds to the AMF 530 with a Handover Request Acknowledge, and the AMF 530 sends a Handover Command to the source node 510 in response to the received Handover Request Acknowledge. In both the Handover Required and the Handover Request message, the traffic steering information, i.e. the calculated SCells and possible other information such as MIMO configuration, can be sent in a IE Source to Target Transparent Container. The traffic steering information is not needed in the AMF 530 and is therefore suitable to send in a transparent container. In NR, the IE Source to Target Transparent Container carries a IE Source NG-RAN Node to Target NG-RAN Node Transparent Container. The extra IE could be called Traffic Steering Data and contain a Suggested SCell list, which contains SCell nCGI, where “n” in nCGI stands for NR.

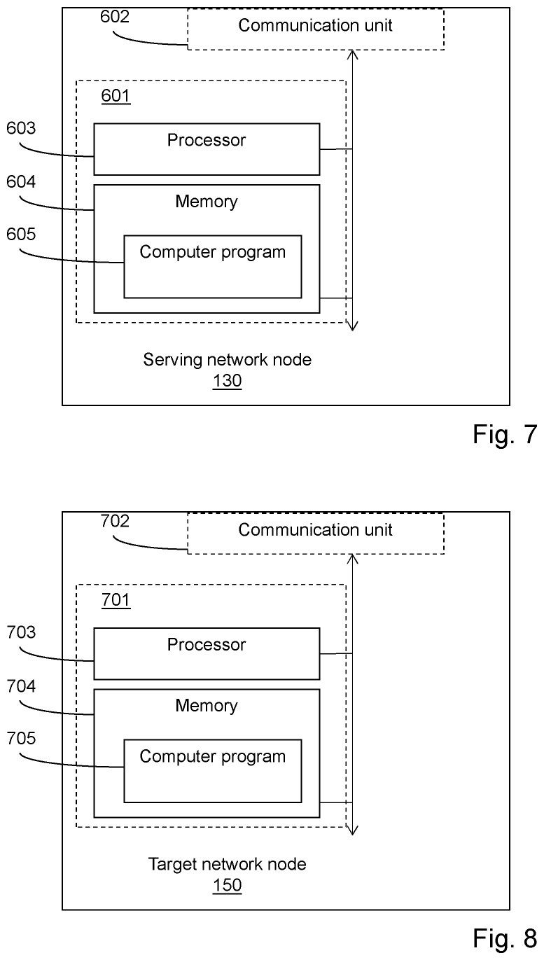

FIG. 7, in conjunction with FIG. 1, describes a serving network node 130 configured to operate in a wireless communication network 100 for serving a UE 140, the serving network node being configured to handle a serving cell 135. The serving network node 130 comprises a processing circuitry 603 and a memory 604. Said memory contains instructions executable by said processing circuitry, whereby the serving network node 130 is operative for determining, based on capabilities of the UE 140, on configuration parameters of neighboring cells 155, 165, 175 and the serving cell 135 as well as on channel quality of signals received by the UE 140 from network nodes 150, 160 handling the neighboring cells 155, 165, 175 as well as on channel quality of signals received by the UE from the serving network node 130, a primary cell 155 and at least one secondary cell 165 for the UE 140. The serving network node 130 is further operative for, when the determined primary cell 155 is handled by a target network node 150, which is different from the serving network node 130, sending a handover message towards the target network node 150, the handover message comprising an ID of the determined primary cell 155 and IDs of the at least one secondary cell 165.

The serving network node 130 may be realized as a group of network nodes, wherein functionality of the serving network node is spread out over the group of network nodes. The group of network nodes may be different physical, or virtual, nodes of the network. This alternative realization may be called a cloud-solution. Also, the target network node 150 may have this alternative realization.

According to an embodiment, the serving network node 130 is operative for the determining of primary cell 155 and at least one secondary cell 165 for the UE 140 by determining a secondary cell group, SCG, comprising a Primary Secondary Cell, PSCell, of the SCG as well as at least one Secondary Cell, SCell, of the SCG, and wherein the handover message further comprises an ID of the PSCell and IDs of the at least one SCell of the SCG.

According to another embodiment, the handover message further comprises MIMO configuration parameters such as number of MIMO layers, or Layer 1 configuration parameters for the UE 140.

According to another embodiment, the handover message further comprises information on channel quality of signals received by the UE 140 from the target network node 150 handling the primary cell 155 and on channel quality of signals received by the UE from the network node 160 handling the at least one secondary cell 165.

According to another embodiment, the handover message further comprises information on which frequencies that were considered for the channel quality when the primary cell and the at least one secondary cell was determined.

According to yet another embodiment, the handover message further comprises information on channel quality of signals received by the UE 140 from network nodes handling other of the neighboring cells that were not being determined as the primary cell or any of the one or more secondary cells, as well as IDs of those cells.

According to other embodiments, the serving network node 130 may further comprise a communication unit 602, which may be considered to comprise conventional means for wireless communication with the wireless device 140, such as a transceiver for wireless transmission and reception of signals in the communication network. The communication unit 602 may also comprise conventional means for communication with other network nodes of the wireless communication network 100, such as the target network node 150. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the serving network node 130 to perform the steps described in any of the described embodiments of the serving network node 130 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the serving network node 130 has access via the communication unit 602. The computer program 605 may then be downloaded from the server into the memory 604.

FIG. 8, in conjunction with FIG. 1, describes a target network node 150 configured to operate in a wireless communication network 100, the target network node being configured to handle a target cell 155. The target network node 150 comprises a processing circuitry 703 and a memory 704. Said memory contains instructions executable by said processing circuitry, whereby the target network node 150 is operative for receiving a handover message from a serving network node 130 serving a UE 140, the handover message comprising an ID of a determined primary cell for the UE, the primary cell being the target cell 155, and IDs of determined at least one secondary cell 165 for the UE, and determining whether to set up the determined target cell 155 as primary cell for the UE and whether to set up the determined at least one secondary cell 165 as secondary cell for the UE.

According to an embodiment, the handover message further comprises ID of a determined PSCell of an SCG for the UE and IDs of a determined at least one SCell of the SCG.

According to another embodiment, the handover message further comprises MIMO configuration parameters such as number of MIMO layers, or Layer 1 configuration parameters for the UE 140.

According to another embodiment, the handover message further comprises information on channel quality of signals received by the UE 140 from the target network node 150 handling the determined primary cell 155 and on channel quality of signals received by the UE from the network node 160 handling the determined at least one secondary cell 165.

According to another embodiment, the handover message further comprises information on which frequencies the serving network node 130 considered when it determined the primary cell and the at least one secondary cell for the UE.

According to yet another embodiment, the handover message further comprises information on channel quality and ID of other cells evaluated by the serving network node but not being determined by the serving network node 130 as the primary cell or any of the one or more secondary cells.

According to other embodiments, the target network node 150 may further comprise a communication unit 702, which may be considered to comprise conventional means for wireless communication with the wireless device 140, such as a transceiver for wireless transmission and reception of signals in the communication network. The communication unit 702 may also comprise conventional means for communication with other network nodes of the wireless communication network 100, such as the serving network node 130. The instructions executable by said processing circuitry 703 may be arranged as a computer program 705 stored e.g. in said memory 704. The processing circuitry 703 and the memory 704 may be arranged in a sub-arrangement 701. The sub-arrangement 701 may be a micro-processor and adequate software and storage therefore, a Programmable Logic Device, PLD, or other electronic component(s)/processing circuit(s) configured to perform the methods mentioned above. The processing circuitry 703 may comprise one or more programmable processor, application-specific integrated circuits, field programmable gate arrays or combinations of these adapted to execute instructions.

The computer program 705 may be arranged such that when its instructions are run in the processing circuitry, they cause the target network node 150 to perform the steps described in any of the described embodiments of the target network node 150 and its method. The computer program 705 may be carried by a computer program product connectable to the processing circuitry 703. The computer program product may be the memory 704, or at least arranged in the memory. The memory 704 may be realized as for example a RAM (Random-access memory), ROM (Read-Only Memory) or an EEPROM (Electrical Erasable Programmable ROM). In some embodiments, a carrier may contain the computer program 705. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 704. Alternatively, the computer program may be stored on a server or any other entity to which the target network node 150 has access via the communication unit 702. The computer program 705 may then be downloaded from the server into the memory 704.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a serving network node of a wireless communication network, the serving network node serving a UE, the serving network node handling a serving cell, the method comprising:
determining, based on capabilities of the UE, on configuration parameters of neighboring cells and the serving cell as well as on channel quality of signals received by the UE from network nodes handling the neighboring cells as well as on channel quality of signals received by the UE from the serving network node, a primary cell and at least one secondary cell for the UE, and
when the determined primary cell is handled by a target network node, which is different from the serving network node, sending a handover message towards the target network node, the handover message comprising an ID of the determined primary cell characterized in that the handover message further comprises ID of the at least one secondary cell.

2. Method according to claim 1, wherein the determining further comprises determining a secondary cell group, SCG, comprising a Primary Secondary Cell, PSCell, of the SCG as well as at least one Secondary Cell, SCell, of the SCG, and wherein the handover message further comprises an ID of the PSCell and ID(s) of the at least one SCell of the SCG.

3. Method according to claim 11, wherein the handover message further comprises MIMO configuration parameters such as number of MIMO layers, or Layer 1 configuration parameters for the UE.

4. Method according to claim 1, wherein the handover message further comprises information on channel quality of signals received by the UE from the target network node handling the primary cell and on channel quality of signals received by the UE from the network node handling the at least one secondary cell.

5. Method according to claim 1, wherein the handover message further comprises information on which frequencies that were considered for the channel quality when the primary cell and the at least one secondary cell was determined.

6. (canceled)

7. A method performed by a target network node of a wireless communication network, the target network node handling a target cell, the method comprising:
receiving a handover message from a serving network node serving a UE, the handover message comprising an ID of a determined primary cell for the UE, the primary cell being the target cell, and ID(s) of determined at least one secondary cell for the UE, and
determining whether to set up the determined target cell as primary cell for the UE and whether to set up the determined at least one secondary cell as secondary cell for the UE.

8. Method according to claim 7, wherein the received handover message further comprises ID of a determined PSCell of an SCG for the UE and ID of a determined at least one SCell of the SCG.

9. Method according to claim 7, wherein the received handover message further comprises MIMO configuration parameters such as number of MIMO layers, or Layer 1 configuration parameters for the UE.

10. Method according to claim 7, wherein the received handover message further comprises information on channel quality of signals received by the UE from the target network node handling the determined primary cell and on channel quality of signals received by the UE from the network node handling the determined at least one secondary cell.

11. Method according to claim 7, wherein the received handover message further comprises information on which frequencies the serving network node considered when it determined the primary cell and the at least one secondary cell for the UE.

12. (canceled)

13. A serving network node configured to operate in a wireless communication network for serving a UE, the serving network node being configured to handle a serving cell, the serving network node comprising a processing circuitry and a memory, said memory containing instructions executable by said processing circuitry, whereby the serving network node is operative for:
determining, based on capabilities of the UE, on configuration parameters of neighboring cells and the serving cell as well as on channel quality of signals received by the UE from network nodes handling the neighboring cells as well as on channel quality of signals received by the UE from the serving network node, a primary cell and at least one secondary cell for the UE, and
when the determined primary cell is handled by a target network node, which is different from the serving network node, sending a handover message towards the target network node, the handover message comprising an ID of the determined primary cell characterized in that the handover message further comprises ID(s) of the at least one secondary cell.

14. Serving network node according to claim 13, operative for the determining of primary cell and at least one secondary cell for the UE by determining a secondary cell group, SCG, comprising a Primary Secondary Cell, PSCell, of the SCG as well as at least one Secondary Cell, SCell, of the SCG, and wherein the handover message further comprises an ID of the PSCell and ID of the at least one SCell of the SCG.

15. Serving network node according to claim 13, wherein the handover message further comprises MIMO configuration parameters such as number of MIMO layers, or Layer 1 configuration parameters for the UE.

16. Serving network node according to claim 13, wherein the handover message further comprises information on channel quality of signals received by the UE from the target network node handling the primary cell and on channel quality of signals received by the UE from the network node handling the at least one secondary cell.

17. Serving network node according to claim 13, wherein the handover message further comprises information on which frequencies that were considered for the channel quality when the primary cell and the at least one secondary cell was determined.

18. (canceled)

19. A target network node configured to operate in a wireless communication network, the target network node being configured to handle a target cell, the target network node comprising a processing circuitry and a memory, said memory containing instructions executable by said processing circuitry, whereby the target network node is operative for:
receiving a handover message from a serving network node serving a UE, the handover message comprising an ID of a determined primary cell for the UE, the primary cell being the target cell, and ID(s) of determined at least one secondary cell for the UE, and
determining whether to set up the determined target cell as primary cell for the UE and whether to set up the determined at least one secondary cell as secondary cell for the UE.

20. Target network node according to claim 19, wherein the handover message further comprises ID of a determined PSCell of an SCG for the UE and ID(s) of a determined at least one SCell of the SCG.

21. Target network node according to claim 19, wherein the handover message further comprises MIMO configuration parameters such as number of MIMO layers, or Layer 1 configuration parameters for the UE.

22. (canceled)

23. Target network node according to claim 19, wherein the handover message further comprises information on which frequencies the serving network node considered when it determined the primary cell and the at least one secondary cell for the UE.

24. Target network node according to claim 19, wherein the handover message further comprises information on channel quality and ID of other cells evaluated by the serving network node but not being determined by the serving network node as the primary cell or any of the one or more secondary cells.

25. A computer program comprising instructions, which, when executed by at least one processing circuitry of a serving network node of a wireless communication network, the serving network node serving a UE and handling a serving cell, causes the serving network node to perform the following steps:
determining, based on capabilities of the UE, on configuration parameters of neighboring cells and the serving cell as well as on channel quality of signals received by the UE from network nodes handling the neighboring cells as well as on channel quality of signals received by the UE from the serving network node, a primary cell and at least one secondary cell for the UE, and
when the determined primary cell is handled by a target network node, which is different from the serving network node, sending a handover message towards the target network node, the handover message comprising an ID of the determined primary cell characterized in that the handover message further comprises ID(s) of the at least one secondary cell.

26. A carrier containing the computer program according to claim 25, wherein the carrier is one of an electronic signal, an optical signal, a radio signal, an electric signal or a computer readable storage medium.

27-28. (canceled)
